(19) United States
(12) Patent Application Publication
(10) Pub. No.: US 2019/0029286 A1
(43) Pub. Date: Jan. 31, 2019

(54) Manufacture of Iced Coffee Beverages

(71) Applicant: Springdale Beverage Company, LLC, Raleigh, NC (US)

(72) Inventors: Edward J. Stempien, III, Raleigh, NC (US); Daniel Lewis Rea, Raleigh, NC (US); Jeffrey Edward Hoffmann, Raleigh, NC (US)

(21) Appl. No.: 15/660,092

(22) Filed: Jul. 26, 2017

(51) Int. Cl. A23F 5/26; C12C 11/00; C12C 1/16; C12H 1/22; A47J 31/00

(52) U.S. Cl. CPC A23F 5/26; C12C 11/00; A47J 31/002; C12H 1/22; C12C 1/16

(57) ABSTRACT

The method and apparatus is provided for making an alcoholic coffee beverage with a look and taste similar to iced coffees with dairy additives. A variety of alcoholic, coffee beverages can be made, such as lattes, mochas, cappuccinos, and espressos, as well as a broad variety of frozen coffee beverages currently available as non-alcoholic beverages. In exemplary embodiments, a fermented malt product, such as beer or ale, is used as the primary brewing medium to cold brew or hot brew coffee. Before carbonation, the fermented malt product is flash pasteurized to kill any remaining yeast and stop the fermentation process. After pasteurization, sweeteners and other flavorings may be added to the fermented malt product, which is then used in a hot or cold brewing process to make the coffee beverage. Dairy products can be added to the cold-brewed or hot brewed coffee beverage. The coffee beverage may be stored in kegs or bottled into individual sized containers.

### TECHNICAL FIELD

The present disclosure relates generally to iced coffee beverages and, more particularly, to iced coffee beverages made using a fermented malt product.

### BACKGROUND

Although iced coffee beverages have been around for many years, they have recently gained in popularity and are now served in coffee shops, such as Starbucks and Dunkin Donuts, throughout the United States. Iced coffee can be made by cold brewing coffee to make a concentrate that can be diluted with water and served over ice. Iced coffee can also be combined with cream and dairy products to make a variety of iced beverages including iced lattes, mochas, and cappuccinos. For many years, iced coffee was a niche market served by a relatively few number of gourmet coffee shops, but recently has gained mainstream acceptance.

Coffee is also finding its way into the beer market. Many craft breweries within the United States now offer coffee-flavored beers. One common method of making coffee-flavored beer is known as the “cold toddy” method. Using the cold toddy method, a concentrated coffee is cold brewed and then blended with the beer. In contrast to iced coffee, cream and dairy products are not used in coffee-flavored beers.

### SUMMARY

The present disclosure provides a method and apparatus for making an alcoholic coffee beverage with a look and taste similar to iced coffees with dairy additives. A variety of alcoholic, coffee beverages can be made, such as lattes, mochas, cappuccinos, and espressos, as well as a broad variety of frozen coffee beverages currently available as non-alcoholic beverages. In exemplary embodiments, a fermented malt product, such as beer or ale, is used as the primary brewing medium to cold brew or hot brew coffee. Before carbonation, the fermented malt product is flash pasteurized to kill any remaining yeast and stop the fermentation process. After pasteurization, sweeteners and other flavorings may be added to the fermented malt product, which is then used to cold brew coffee. Alternatively, the fermented malt product may be used to hot brew coffee using the fermented malt product as the primary brewing medium and then cooled. Dairy products can be added to the cold-brewed or hot brewed coffee beverage. The coffee beverage may be stored in kegs or bottled into individual sized servings. In the case of bottling, the dairy product can be added before or during the bottling process.

### BRIEF DESCRIPTION OF THE DRAWINGS

FIG. 1 illustrates process equipment for making an iced coffee beverage.

FIG. 2 illustrates a kegging system for filling kegs with the coffee beverage.

FIG. 3 illustrates hot fill bottling equipment for filling bottles with the coffee product.

FIG. 4 illustrates exemplary process equipment for making an iced coffee beverage using a concentrated fermented malt product and a concentrated coffee product.

FIG. 5 illustrates another exemplary process equipment for making an iced coffee beverage using a concentrated fermented malt product and a concentrated coffee product.

FIG. 6 illustrates process equipment for making a fermented malt product that is used to make an iced coffee beverage.

FIG. 7 illustrates a first exemplary method for making a coffee product using a fermented malt product.

FIG. 8 illustrates a second exemplary method for making a coffee product using a concentrated fermented malt product.

FIG. 9 illustrates a third exemplary method for making a fermented malt product for use in brewing coffee.

### DETAILED DESCRIPTION

The present disclosure provides processes and apparatus for making a coffee beverage using a fermented malt product. The fermented malt product is flash pasteurized prior to forced carbonation and the fermented malt product is used to brew coffee. After pasteurization and prior to brewing coffee, sweeteners, extracts (e.g., vanilla) or other flavorings may be added to the fermented malt product. The fermented malt product, following pasteurization, is used to cold brew or hot brew a coffee beverage. After filtering, the coffee beverage may be combined with a pasteurized milk product and bottled or kegged. The coffee beverage may be bottled or kegged with or without the added dairy product. After bottling or kegging, the coffee beverage may be cooled and stored for service at a later time.

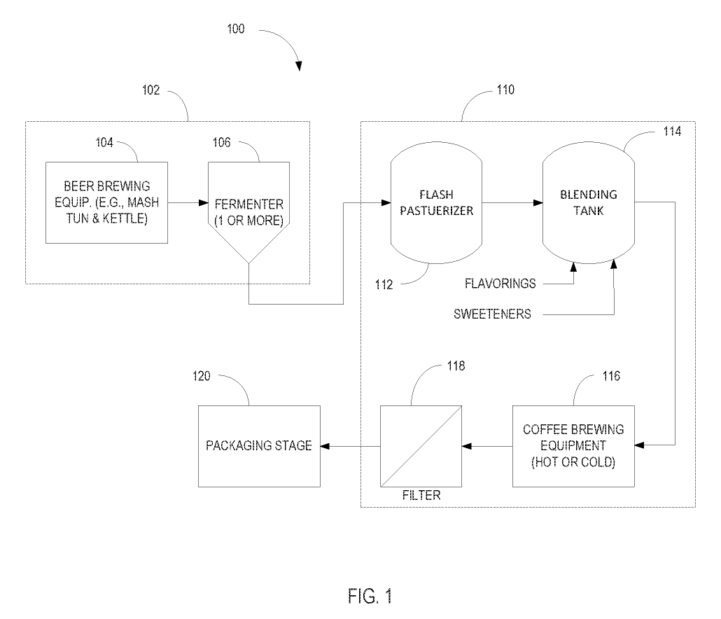

FIG. 1 illustrates exemplary process equipment 100 for manufacturing an iced coffee beverage. The process equipment 100 can be divided into three stages: a fermented malt production stage 102, a coffee production stage 110, and a packaging stage 120. The fermented malt production stage 102 comprises the equipment for producing a fermented malt product for subsequent use in the coffee production stage 110. The coffee production stage 110 comprises the equipment for making coffee using the fermented malt product. The packaging stage 120 comprises the equipment for packaging the coffee beverage. The coffee beverage can be packaged in kegs, bottles, cans, or other liquid containers.

Fermented malt production stage 102 includes for example, beer brewing equipment 104 (e.g., mash tun and kettle) for making a wort, and one or more fermenters 106 for fermenting the wort to produce the fermented malt product. Any beer style may be used to make the coffee beverage including lagers, pilsners, amber ales, porters, stouts, or other ales. Also, the fermented malt product may have any desired alcohol concentration, but generally will be in the range of 2%-12%. In some embodiments, the fermentation step may include a primary fermentation step and a secondary fermentation step where the fermented malt product is conditioned. Multiple fermenters 106 may be used to perfrom primary and secondary fermentation. The fermented malt product output from the final fermenter 106 is fed to the coffee production stage 110. Coffee production stage 110 includes, for example, a flash pasteurizer 112, blending tank 114, coffee brewing equipment 116, and, optionally, a filter 118. Flash pasteurizer 112 pasteurizes the fermented malt product to kill any remaining yeast and stop the fermentation process. Pasteurization is preferably performed prior to any forced carbonation step. After fermentation, the fermented malt product will contain low levels of carbonation, referred to as residual CO2, which is a natural by-product of the fermentation process. The amount of the residual CO2 will depend on the temperature and pressure of the fermented malt product. Preferably, the amount of residual CO2 is not more than 1.5 Volumes of CO2 (referred to herein as low carbonation), and more preferably not more than 1.2 Volumes (referred to herein as very low carbonation).

Following pasteurization, the fermented malt product is fed to blending tank 114 where sweeteners and flavorings are added to achieve a desired flavoring. Typical flavorings include vanilla extracts, chocolate or caramel syrups, fruit syrups (e.g., blackberry syrup), mint syrups, almond syrups, extracts of cinnamon or other spices, or any other desired flavorings. A blanket of CO2 or nitrogen may be applied to the fermented malt product in the blending tank 114 to eliminate oxygen. In some variations, the blending tank 114 may include a heat exchanger (not shown) to cool the fermented malt product as needed to properly dissolve the sweeteners, extracts or other flavorings. Alternatively, a heat exchanger may be used to cool the fermented malt product before its introduction into the blending tank 114.

Fermented malt product output from the blending tank 114 is fed to coffee brewing equipment 116 to use in the brewing of coffee. The type of coffee, coarseness of the grounds, caffeine content, and other aspects of the coffee can be selected to achieve the desired taste or characteristics. Any conventional method of brewing coffee can be used. For example, the coffee beverage can be hot brewed or cold brewed. To cold brew the coffee, selected coffee beans and/or coffee grounds are steeped in the fermented malt product for 12 to 24 hours. To hot brew the coffee beverage, the fermented malt product may be poured over coffee grounds and filtered. The addition of water is unnecessary because the fermented malt product is used as the brewing medium. However, some water may be added to dilute the alcohol concentration to a desired level.

The brewed coffee beverage may optionally be directed to a filter 118 to filter the coffee beverage. Filtering the coffee beverage may be need to remove small coffee grounds or other suspended solids from the coffee beverage and to clarify the coffee beverage.

After filtering, the coffee beverage is fed to packaging stage 120. In the packaging stage 120, the coffee product is packaged into beverage containers, such as kegs, bottles, cans, or other beverage containers.

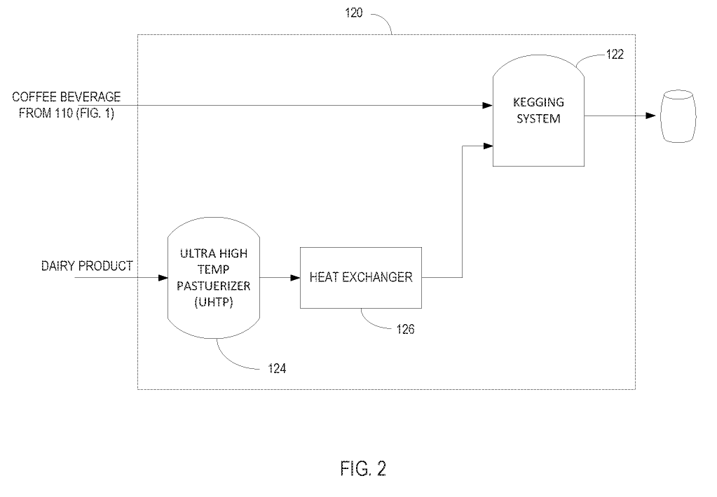

FIG. 2 illustrates an exemplary packaging stage 120 including a kegging system 122 for filling kegs with the coffee beverage. Once the kegs are filled, the kegs may be pressurized with CO2 to carbonate the coffee beverage if desired. Alternatively, the kegs can be maintained at low pressures sufficient to dispense the coffee beverage from the keg. The pasteurized dairy product may be combined with the coffee beverage in the keg. The pasteurized dairy product may be added to the coffee beverage prior to or during the keg filling process. Referring to the example in FIG. 2, the dairy product is pasteurized in an Ultra High Temperature Pasteurizer (UHTP) 124, cooled in a heat exchanger 126, and then fed to the kegging system 122 where it is mixed with the coffee beverage. The kegs may then be stored at a proper temperature to avoid spoiling of the diary product. The coffee beverage may be served to customers directly from the keg. A pasteurized dairy product can be added at the time of service if the coffee beverage does not already have a dairy additive.

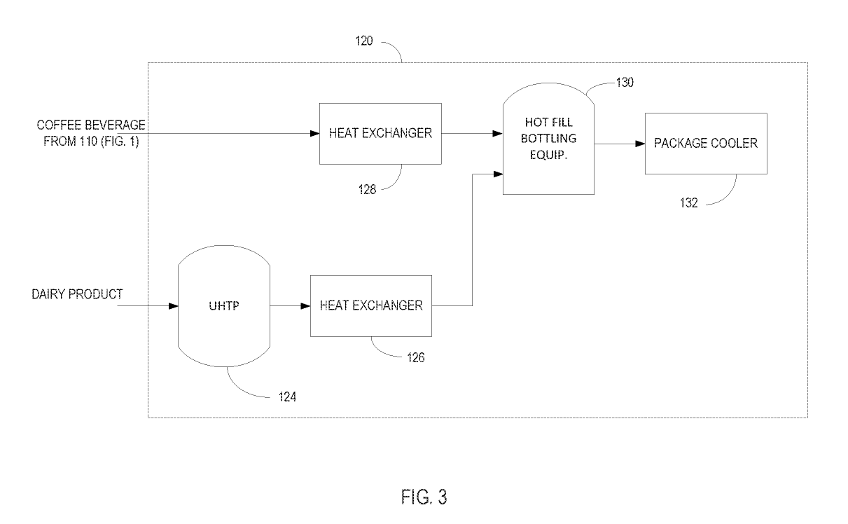

FIG. 3 illustrates an embodiment for packaging the coffee beverage with dairy additives for individual servings using a hot fill bottling equipment 130. In this example, the coffee beverage is produced using the process shown in FIG. 1. For convenience, the fermented malt production stage 102 and coffee production stage 110, which have been previously described, are not shown. The coffee beverage from the coffee production stage 110 (FIG. 1) is input to a heat exchanger 128 which heats the coffee beverage to a desired hot filling temperature, typically in the range of 140-200°. A dairy product to be added to the coffee beverage is fed to an UHTP 124 to be pasteurized and then cooled in a heat exchanger 126 to the hot filled bottling temperature. The pasteurized dairy product, along with the coffee beverage, are fed to hot fill bottling equipment 130 which fills suitable containers, such as glass bottles or PET bottles, with a mixture of the coffee beverage and dairy product in a desired proportion, and applies a button seal lid to the bottles to seal the coffee beverage in the bottles. The warm bottles are then passed through a package cooler 132 to quickly cool the bottles to a desired temperature for storage.

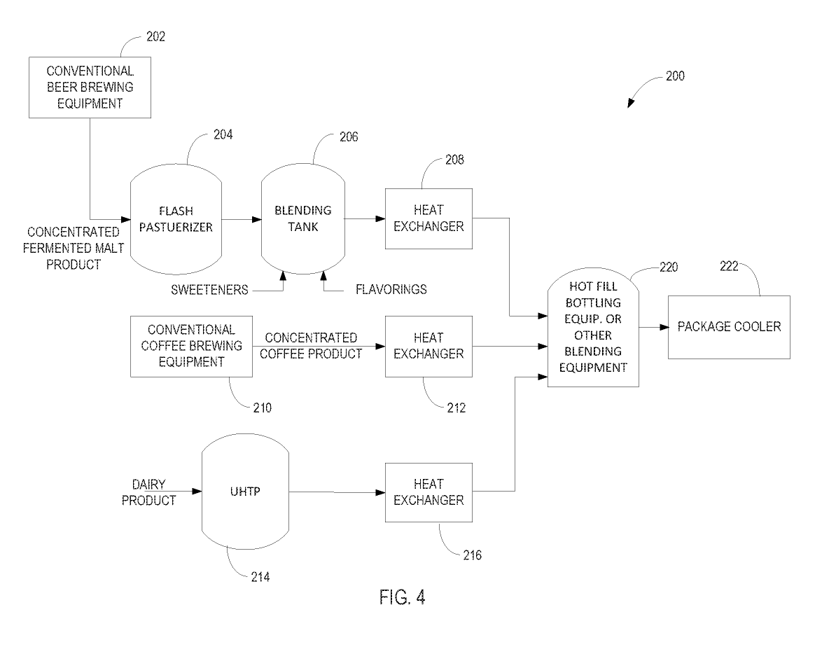

FIG. 4 illustrates process equipment 200 for making a coffee beverage according to a second embodiment. In this example, a concentrated fermented malt product and a concentrated coffee product are prepared using conventional beer brewing and coffee brewing methods. The concentrated fermented malt product is prepared in conventional beer brewing equipment 202. The concentrated fermented malt has a lower water to malt ratio (and thus a higher alcohol concentration) than the final coffee beverage being produced. For example, if the desired alcohol concentration for the coffee beverage is 3%, the concentrated fermented malt product may have a concentration of 4% if blended with the concentrated coffee product in a 3:1 ratio. The concentrated coffee product in this case is brewed with water using conventional coffee brewing equipment 210, e.g., hot brewing or cold brewing equipment. The concentrated coffee product has a lower water ratio (and therefore a stronger coffee) than the coffee beverage to be produced. For example, if mixed with a 1:3 ratio with the concentrated fermented malt product, the concentrated coffee product would need to be four times stronger.

The concentrated fermented malt product is fed to a flash pasteurizer 204 where the concentrated fermented malt product is pasteurized to kill the remaining yeast and stop the fermentation process. After pasteurization, the concentrated fermented malt product is fed to a blending tank 206 where sweeteners and other flavorings are added as previously described. The concentrated fermented malt product from the blending tank 206 and concentrated coffee product are fed to respective heat exchangers 208 and 212, and heated to a hot fill bottling temperature. If a dairy additive is used, a dairy product is fed to a UHTP 214 to be pasteurized and then cooled in heat exchanger 216 to the hot fill bottling temperature. Following temperature adjustment, the concentrated fermented malt product, concentrated coffee product, and pasteurized dairy product are input to hot fill bottling equipment 220. The hot fill bottling equipment 220 blends the concentrated fermented malt product, concentrated coffee product, and pasteurized dairy product in a desired ratio to make the coffee beverage, fills suitable containers such as glass bottles or PET bottles with the coffee beverage, and applies a button seal lid to the bottles to seal the coffee beverage in the bottles. The warm bottles are then passed through a package cooler 222 to quickly cool the bottles to a desired temperature for storage.

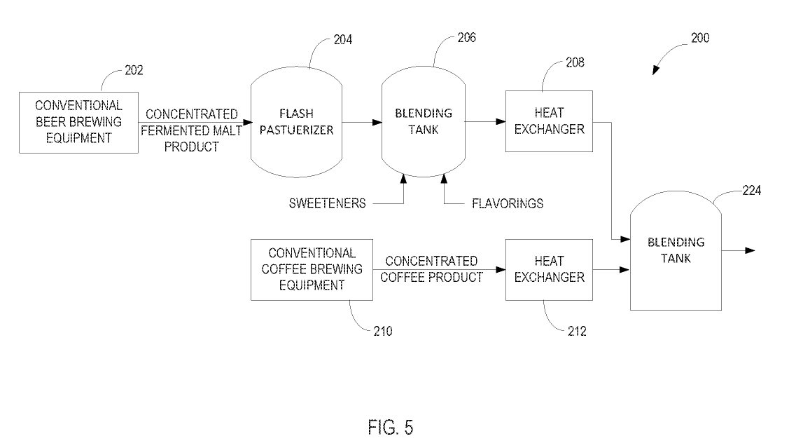

FIG. 5 illustrates an alternate embodiment similar to the embodiment in FIG. 4 where the hot-fill bottling equipment 220 is replaced by a blending tank 224 or other blending equipment to blend the concentrated fermented malt product and concentrated coffee product output to make the coffee beverage. The coffee beverage output from the blending tank 224 can then be kegged or bottled, with or without a dairy additive, as shown and described in FIGS. 2 and 3 and the accompanying text.

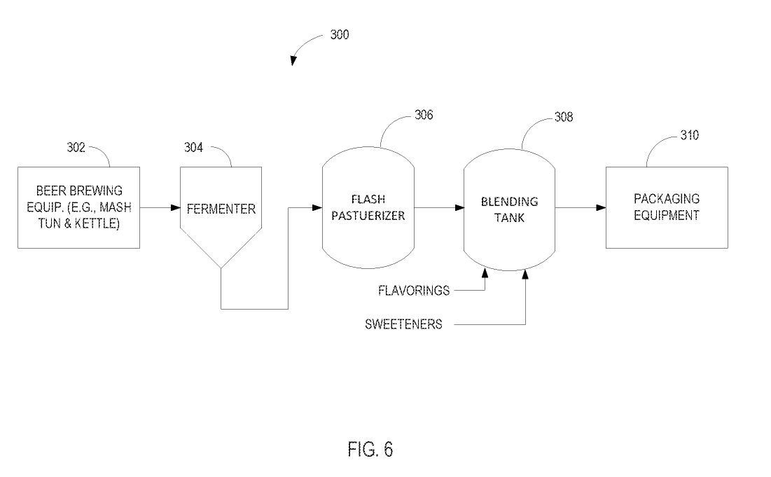

FIG. 6 shows processing equipment 300 for producing a fermented malt product that can be sold or distributed for use in making an alcoholic coffee beverage as previously described. The processing equipment 300 includes beer brewing equipment 302 for brewing beer. The beer brewing equipment 302, for example, comprises a mash tun for generating a mash and a kettle for boiling the mashed grains to produce a wort. The wort is fed to a fermenter 304 where the wort is fermented for a period of time to produce a fermented malt product. The fermented malt product may have an alcohol concentration in the range of 2%-12%. The fermented malt product is not subjected to forced carbonation or secondary fermentation. Rather, the fermented malt product with residual CO2 levels is immediately input to a flash pasteurizer 306. The flash pasteurizer 306 pasteurizes the fermented malt product to kill any remaining yeast and stop the fermentation process. After pasteurization, the fermented malt product may optionally be fed to a blending tank 308 where sweeteners and flavorings are added as previously described. The fermented malt product, with or without added sweeteners and flavorings, is then packaged in beverage containers, such as kegs or bottles, for storage and shipment by suitable packaging equipment 310.

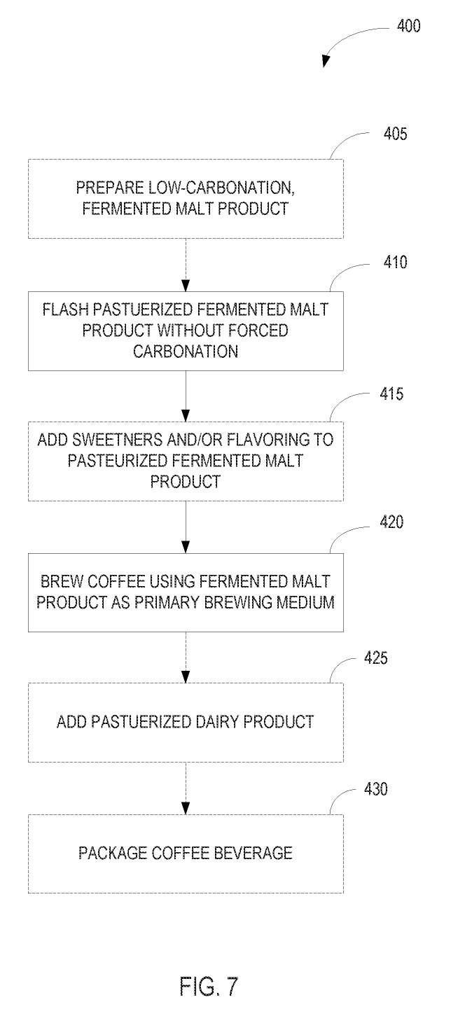

FIG. 7 illustrates an exemplary method 400 for making a coffee beverage. Steps illustrated by dotted lines are considered optional. This method may be used with the equipment 100 shown in FIG. 1. A low carbonation, fermented malt product is prepared or otherwise obtained for use in making the coffee product (block 405). As previously described, the low carbonation, fermented malt product may be brewed using conventional brewing equipment. The fermented malt product is flash pasteurized without prior forced carbonation (block 410). Sweeteners or other flavorings are added to the fermented malt product (block 415). The fermented malt product is then used as the primary brewing medium to brew coffee (block 420). Either a cold brewing or hot brewing process may be used. A pasteurized dairy product is optionally added to the coffee beverage (block 425) and the coffee beverage, with or without the added dairy product, is packaged (block 430). FIGS. 2 and 3 illustrate exemplary methods for packaging the coffee product.

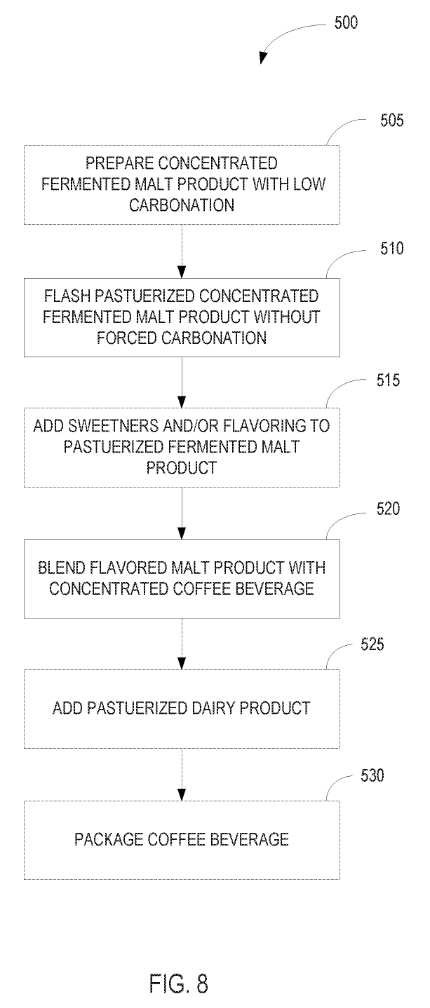

FIG. 8 illustrates another exemplary method 500 for making a coffee beverage. Steps illustrated by dotted lines are considered optional. This method may be used with the equipment 200 shown in FIG. 4. A concentrated fermented malt product with only residual CO2 levels is prepared or otherwise obtained for use in making the coffee beverage (block 505). As previously described, the concentrated fermented malt product may be brewed using conventional brewing equipment. The concentrated fermented malt product is flash pasteurized without prior forced carbonation (block 510). Sweeteners or other flavorings are added to the fermented malt product (block 515). The fermented malt product is then blended in desired proportions with a concentrated coffee product prepared by hot or cold brewing (block 520). A pasteurized dairy product is optionally added to the coffee beverage (block 525) and the coffee beverage, with or without the added dairy product, is packaged (block 530). FIGS. 2 and 3 illustrate exemplary methods for packaging the coffee product.

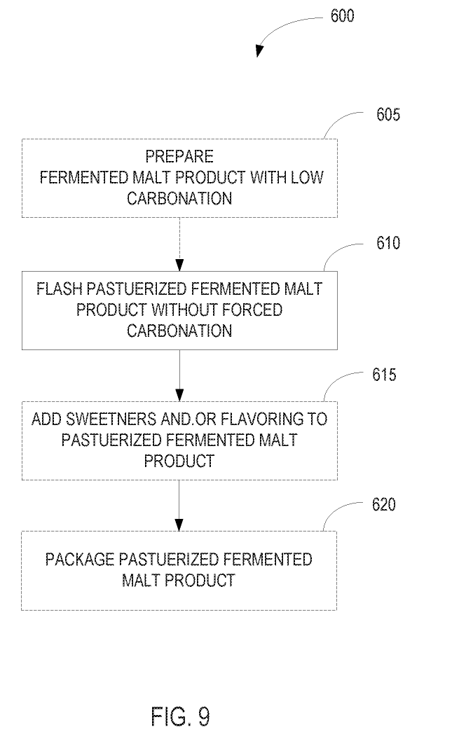

FIG. 9 illustrates an exemplary method 600 for making a fermented malt product that is used to brew an alcoholic coffee beverage. Steps illustrated by dotted lines are considered optional. This method may be used with the equipment 300 shown in FIG. 5. A fermented malt product with only residual CO2 levels is prepared or otherwise obtained (block 605). The fermented malt product may be concentrated or non-concentrated. As previously described, the concentrated fermented malt product may be made using conventional brewing equipment. The fermented malt product is flash pasteurized without prior forced carbonation (block 610). Sweeteners or other flavorings are added to the fermented malt product (block 615). The fermented malt product, with or without added sweeteners and flavorings, is packaged (block 620). FIGS. 2 and 3 illustrate exemplary methods for packaging the coffee product.

What is claimed is:

1. A method of making a coffee beverage comprising:
preparing a fermented malt product using malted grains;
flash pasteurizing the fermented malt product without previous forced carbonation; and
brewing coffee with the fermented malt product to make the coffee beverage.

2. The method of claim 1 further comprising adding sweeteners and/or flavorings to the fermented malt product prior to the brewing.

3. The method of claim 1 further comprising adding a pasteurized dairy product to the coffee beverage.

4. The method of claim 3 further comprising bottling the coffee beverage and adding the pasteurized dairy product to the coffee beverage prior to or during the bottling of the coffee beverage.

5. The method of claim 1 further comprising storing the coffee beverage in a keg.

6. The method of claim 5 further comprising adding a pasteurized dairy product to the coffee beverage stored in the keg.

7. A method of making an alcoholic coffee beverage comprising:
preparing a concentrated fermented malt product using malted grains;
flash pasteurizing the concentrated fermented malt product prior to [without] carbonation;
blending the concentrated fermented malt product with a concentrated coffee product to make the coffee beverage.

8. The method of claim 7 further comprising adding sweeteners and/or flavorings to the concentrated fermented malt product prior to blending with the concentrated coffee product.

9. The method of claim 7 further comprising adding a pasteurized dairy product to the coffee beverage.

10. The method of claim 9 further comprising bottling the coffee beverage and adding the pasteurized dairy product to the coffee beverage prior to or during the bottling of the coffee beverage.

11. The method of claim 7 further comprising storing the coffee beverage in a keg.

12. The method of claim 11 further comprising adding a pasteurized dairy product to the coffee beverage stored in the keg.

13. A method of making a coffee beverage comprising:
flash pasteurizing a low carbonation, fermented malt product without previous forced carbonation; and
brewing coffee with the fermented malt product to make the coffee beverage.

14. The method of claim 13 further comprising adding sweeteners and/or flavorings to the fermented malt product prior to the brewing.

15. The method of claim 13 further comprising adding a pasteurized dairy product to the coffee beverage.

16. The method of claim 15 further comprising bottling the coffee beverage and adding the pasteurized dairy product to the coffee beverage prior to or during the bottling of the coffee beverage.

17. The method of claim 13 further comprising storing the coffee beverage in a keg.

18. The method of claim 17 further comprising adding a pasteurized dairy product to the coffee beverage stored in the keg.

19. A system for making a coffee beverage comprising:
a flash pasteurizer to pasteurize a low carbonated, fermented malt product without previous forced carbonation; and
coffee brewing equipment downstream from the flash pasteurizer and configured to brew coffee with the pasteurized fermented malt product to make the coffee beverage.

20. The system of claim 19 further comprising a blending tank configured for adding sweeteners and/or flavorings to the fermented malt product prior to the brewing.

21. The system of claim 19 further comprising hot fill bottling equipment for filling bottles with the coffee beverage, said hot fill bottling equipment configured to add a pasteurized dairy product to the coffee beverage.

22. The system of claim 19 further comprising a kegging system for filling kegs with the coffee beverage, said kegging system configured to add a pasteurized dairy product to the coffee beverage.

23. A system for making a coffee beverage comprising:
a flash pasteurizer to pasteurize a concentrated fermented malt product without previous forced carbonation; and
coffee brewing equipment configured to brew a concentrated coffee product; and
blending equipment for blending the concentrated fermented malt product and concentrated coffee product.

24. The system of claim 23 further comprising a blending tank configured for adding sweeteners and/or flavorings to the fermented malt product prior to the brewing.

25. The system of claim 23 wherein the blending equipment comprises hot fill bottling equipment for filling bottles with the coffee beverage, said hot-fill bottling equipment configured to add a pasteurized dairy product to the coffee beverage.

26. The system of claim 23 further comprising a kegging system for filling kegs with the coffee beverage, said kegging system configured to add a pasteurized dairy product to the coffee beverage.

27. A system for making a fermented malt product used to brew a coffee beverage comprising:
brewing equipment for making a fermented malt product; and
a flash pasteurizer to pasteurize the fermented malt product without previous forced carbonation.
